(19) United States
(12) Patent Application Publication
(10) Pub. No.: US 2011/0134494 A1
(43) Pub. Date: Jun. 9, 2011

(54) IMAGE SCANNING APPARATUS, CONTROL METHOD FOR IMAGE SCANNING APPARATUS, AND STORAGE MEDIUM

(75) Inventor: Yasushi Shinto, Inagi-shi (JP)

(73) Assignee: CANON KABUSHIKI KAISHA, Tokyo (JP)

(21) Appl. No.: 12/958,754

(22) Filed: Dec. 2, 2010

(30) Foreign Application Priority Data
Dec. 8, 2009 (JP) 2009-278549

(51) Int. Cl. H04N 1/04

(52) U.S. Cl. 358/474

(57) ABSTRACT

A control method for controlling an image reading apparatus includes reading a document having a plurality of pages which is conveyed by a document conveyance device, by a reading unit, checking image data of each page of the document having the plurality of pages read by the reading unit, and controlling, when the document having the plurality of pages set on the document conveyance device is conveyed after the document having the plurality of pages is read by the reading unit, conveyance of the document to stop at timing according to a result of the checking, and is useful in efficiently determining whether scanning of the document failed, such that a user can easily remove a failed page.

### BACKGROUND OF THE INVENTION

1. Field of the Invention

The present invention relates to an image scanning apparatus, a control method for an image scanning apparatus, and a storage medium.

2. Description of the Related Art

Conventionally, there is a technique useful for analyzing an image of a document scanned by a scanner by using a computer, and recognizing, for example, characters on a sheet of the document. If this technique is used, for example, an amount of money or a date written on a great number of forms can be easily extracted, and the extracted data can be used for processing such as summing up the data. However, in order to realize automatic processing of the above-described processing, it is necessary to notify the computer of the type of data included in each portion of the sheet.

According to a conventional technique, for example, an answer sheet being a processing object and a processing instruction sheet are scanned by scan processing. The processing instruction sheet includes a space that suggests where the information should be filled out and the processing content of the information. By acquiring processing instruction information from the data obtained by scanning the processing instruction sheet and analyzing the acquired processing instruction information, the region where information has been filled out and the processing content of such a region are recognized.

Further, if processing is performed according to the processing instruction information, and a failed page is included as a result of the determination, the scan processing is stopped and the scanner will be in a waiting mode with respect to the scanning of the next page. Such a technique is, for example, discussed in Japanese Patent Application Laid-Open No. 2008-160284.

However, according to the above-described conventional technique, when processing is performed according to the processing instruction information, and further, if the result of the processing is determined not to be good, the scanning of the sheets will be stopped at the time the determination is made. Thus, if a great number of pages are processed, the processing needs to be started again from the next page each time the determination result is not good. Thus, the user is unable to leave the place of the scanning apparatus.

Further, if the sheets include a failed page and the user is informed of such a result after the determination of all the sheets is finished, the user needs to pick up the failed page from the paper stack after the determination.

### SUMMARY OF THE INVENTION

The present invention is directed to an image scanning apparatus including a reading unit used for reading a document having a plurality of pages conveyed by a document conveyance device, a checking unit used for checking image data of each page of the plurality pages of the document read by the reading unit, and a control unit used for stopping conveyance of the document at timing which is determined according to a check result performed by the checking unit when the document having the plurality of pages set on the document conveyance device is conveyed after the document having the plurality of pages is read by the reading unit.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram of a configuration of an image processing apparatus according to an exemplary embodiment of the present invention.

FIGS. 2A, 2B and 2C illustrate examples of form information processed by the image processing apparatus.

FIG. 3 is a flowchart illustrating data processing procedures of the image processing apparatus.

FIG. 4 is a flowchart illustrating a data processing procedure of the image processing apparatus.

FIGS. 5A and 5B illustrate user interface displayed on an operation unit.

FIG. 6 is a flowchart illustrating a data processing procedure of the image processing apparatus.

FIG. 7 illustrates a scan ticket of the image processing apparatus.

FIG. 8 is a flowchart illustrating a data processing procedure of the image processing apparatus.

### DESCRIPTION OF THE EMBODIMENTS

Various exemplary embodiments, features, and aspects of the invention will be described in detail below with reference to the drawings.

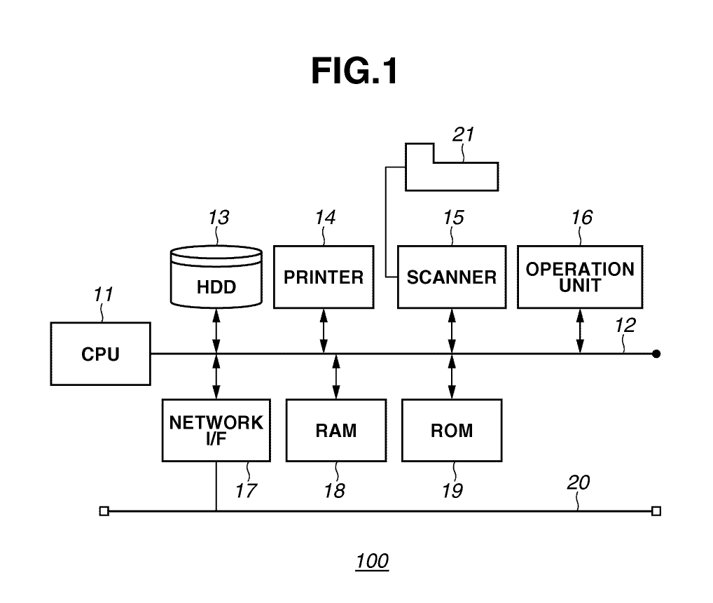

FIG. 1 is a block diagram of a configuration of an image processing apparatus according to a first exemplary embodiment of the present invention. In FIG. 1, although a multifunction peripheral including various functions such as a copy function and a scanner function is described as an example of an image processing apparatus 100 according to the present embodiment, a plurality of apparatuses having such functions as a whole may also be connected and used together as an exemplary embodiment of the present invention.

A CPU 11 controls the entire operation of the image processing apparatus 100 by loading a program stored in a read-only memory (ROM) 19 into a random access memory (RAM) 18. Further, the CPU 11 communicates with each of the units that constitute the image processing apparatus 100 via a bus 12. An operation unit 16 includes a plurality of keys and a touch panel which are used when a user gives an instruction and also a display unit that displays various types of information that the user needs to be notified. A scanner 15 scans an image of a document set on a document positioning plate by the user as a color image, and stores the acquired electronic data (image data) in a storage unit such as a hard disk drive (HDD) 13 or the RAM 18.

The HDD 13 is a hard disk drive including a hard disk and stores various types of information. The scanner 15 includes a document conveyance device (ADF) 21. The scanner 15 sequentially feeds a plurality of pages of document set on the document conveyance device (ADF) 21 to the document positioning plate and scans the document.

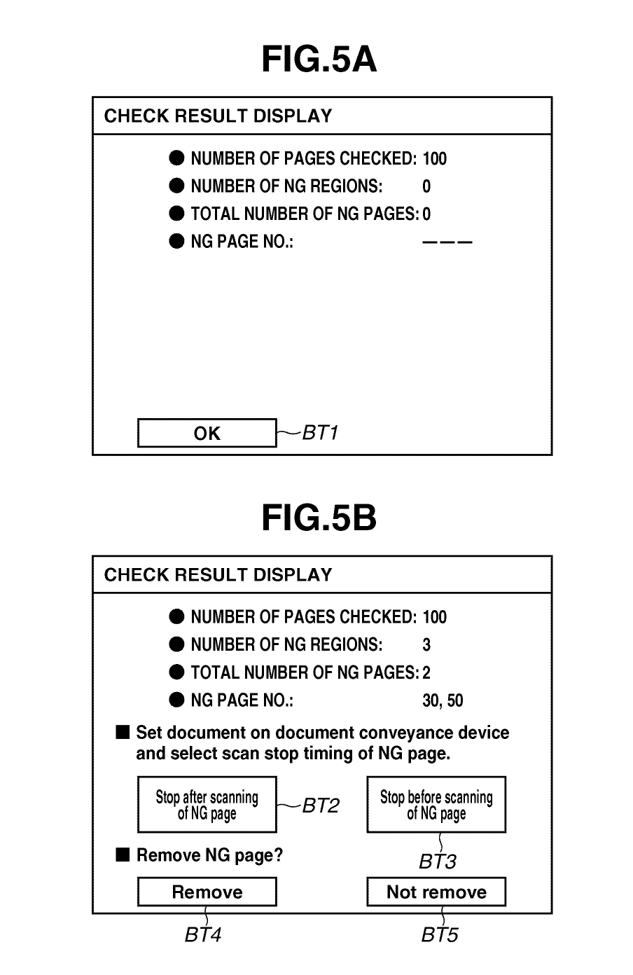

The conveyance of the plurality of pages of the document set on the document conveyance device (ADF) 21 is controlled by the CPU 11. More particularly, when a first document and a second document that contains a plurality of pages described below are scanned, operations to stop and resume the scanning processing of the second document are controlled by the CPU 11 based on a scanning condition and a processing condition which are set by buttons illustrated in FIG. 5B. Further, the scanning processing is resumed when instruction to resume scanning of the document is given by the user operating the operation unit 16 just before or just after the second document that does not include information that should have been included is scanned.

A printer 14 prints an image based on image data, which has been input, on a recording sheet. A network I/F 17 connects the image processing apparatus 100 to a network 20 and controls transmission of data to and from an external apparatus on the network. According to the present invention, the printer 14 can be either an ink jet printer or an electrophotographic printer.

Further, according to the present embodiment, although image data used for the processing described below is input via the scanner 15, similar processing can be performed if image data is input via, for example, the network I/F 17. Further, if image data is transmitted to a personal computer (PC) or the like to which the scanner 15 and the printer 14 are connected, similar processing can be performed by the personal computer. In this case, a part or whole of the program used in the present embodiment can be provided to the PC via a network. Further, a part or whole of the program can be stored in a storage medium such as a CD-ROM and then provided to the PC.

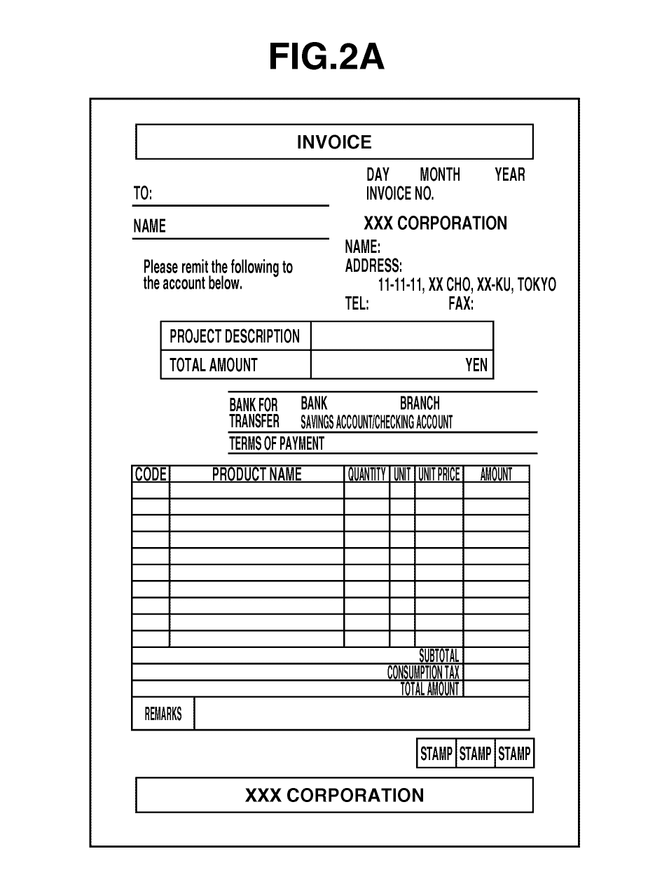

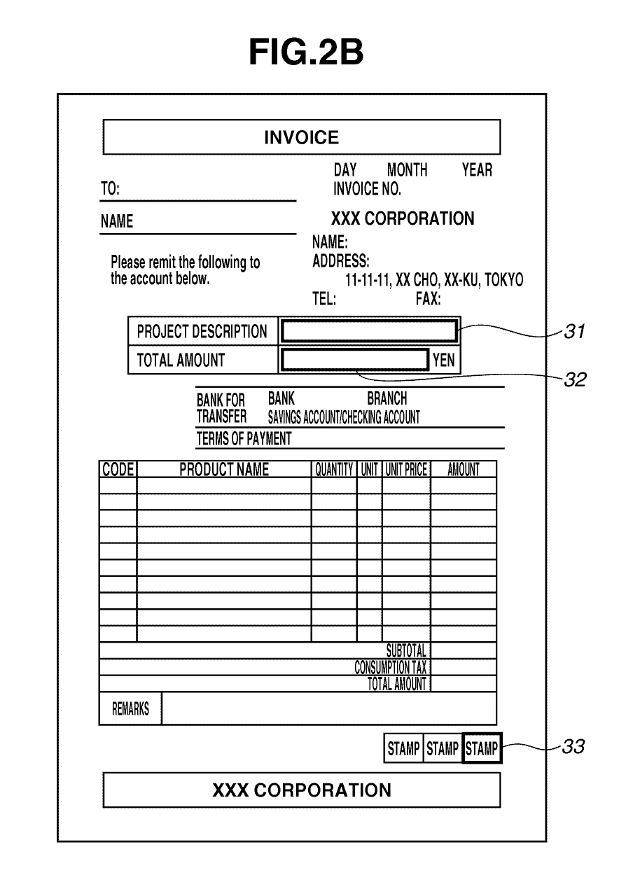

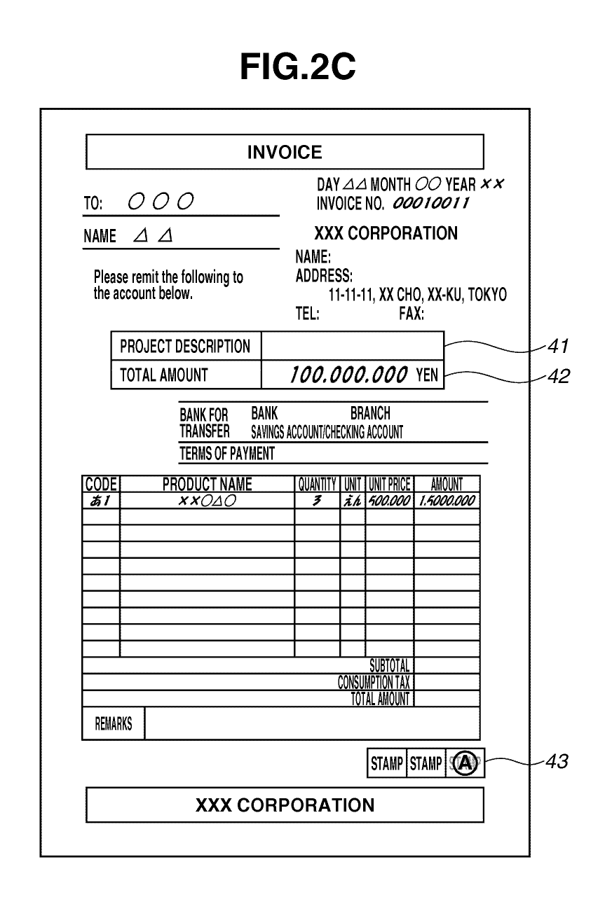

Next, an example of the document used according to the present embodiment will be described. FIGS. 2A to 2C illustrate examples of form information processed by the image processing apparatus according to the present embodiment.

FIG. 2A illustrates an example of a form of a document which is used according to the present embodiment. The document is an invoice, and a processing instruction sheet described below is not yet added to the form by the user. The invoice includes regions where a company name to which the invoice is to be sent, a person in charge of the company, project name, total amount, product name, quantity, unit, unit price, amount, bank for transfer, subtotal, tax such as consumption tax, and remarks are written. Further, the invoice includes a region where a seal of an issuer is stamped.

When the user officially issues this invoice, the user adds information including project name, product name, quantity, unit, unit price, amount, and seal of the issuer. According to the present embodiment, a certain column of the invoice designated by the user is checked so as to determine whether information is added to the column, and further, whether another column designated by the user is blank.

FIG. 2B is an example of the document where an arbitrary region to be checked among the items included in the document illustrated in FIG. 2A is marked by the user using a color pen. The document illustrated in FIG. 2B will be the processing instruction sheet (check ticket). The processing instruction sheet is generated when the user who checks the generated invoice adds processing instruction information, which is described below, to a sheet having the same format as the invoice to be checked. In other words, the processing instruction sheet is the invoice illustrated in FIG. 2A having the processing instruction information added to it. According to the present embodiment, the user marks a corresponding region using a color pen or the like and draws a rectangle so as to form a closed region and designate the region to be processed.

Next, the processing instruction information (additional information) added to the invoice (document) will be described.

In FIG. 2B, a region 31 is defined by a blue rectangle, a region 32 is defined by a green rectangle, and a region 33 is defined by a red rectangle. All of these rectangles are drawn by the user using a color pen. Colors other than those described above can also be used in defining the regions. Further, the number of the colors is not limited to three and it can be increased or reduced according to the check content. Furthermore, although a color pen is used according to the present embodiment, other writing instrument can also be used so long as it can add color to the sheet.

By operating the operation unit 16, the user stores the color which the user uses for the processing instruction information and the processing content corresponding to the color in association with each other, in the RAM 18 in advance. In other words, check points as to whether the region in the blue rectangle is blank, the region in the green rectangle includes information, and the region in the red rectangle includes a seal or a signature, are stored in the RAM 18.

The CPU 11 determines a color component (e.g., hue) of each color registered according to the user's operation and stores the result in the RAM 18. Instead of registering the color using the operation unit 16, the color can also be registered using the scanner 15. In this case, the scanner scans and registers what the user has written on the sheet. Further, the registration can be made not only by the user. For example, the registration can be stored in advance in the image processing apparatus 100. If the content stored in the image processing apparatus 100 is to be used, the user adds the processing instruction information to the document according to the registered color and processing content.

In this way, the user registers the color component to be used for the processing instruction information and the processing content that corresponds to the color component in the RAM 18, and then generates the processing instruction sheet according to the color component and the processing content. The CPU 11 instructs the scanner 15 to scan the processing instruction sheet (check ticket (corresponding to the first document)). Then by analyzing and recognizing the scanned image, the CPU 11 extracts processing instruction information of the document to be scanned. After then, the CPU 11 recognizes the processing content of the document to be checked according to the extracted result. In this manner, the CPU 11 of the image processing apparatus 100 checks whether a specified region in the document includes information, and whether another region does not include information, and another region is stamped with respect to the document to be checked.

FIG. 2C illustrates an example of a document to be checked (corresponding to a second document) according to the present embodiment. The document to be checked is based on a document whose form is same as that of the documents illustrated in FIGS. 2A and 2B.

According to the present embodiment, according to the processing flow described below, when the documents to be checked which are fed from the document conveyance device 21 are continuously scanned, the CPU 11 extracts the processing instruction information which is added to the document to be checked as illustrated in FIG. 2B. Then, according to the extracted result, if no information is included in a region 41 (i.e., it is blank), if information is included in a region 42, and if a region 43 is stamped, the CPU 11 determines that the document is normal.

Since the example in FIG. 2C is a document that satisfies all the conditions used in the determination, the document is determined as normal. If even one condition is determined as not satisfying, the document is determined as NG. The check content and the regions are not limited to those described above and different content or other regions can also be checked.

Next, the process for generating a check ticket used for checking the content of the document based on the processing instruction sheet illustrated in FIG. 2B will be described. According to the present embodiment, the check ticket is represented in a form (e.g., QR code) by which the image processing apparatus 100 can recognize the instruction content illustrated in FIG. 2B and a check method of the document to be checked such as the one illustrated in FIG. 2C. The ticket is represented in a form that is recognizable by the image processing apparatus 100.

The check ticket includes the instruction content obtained from the document in FIG. 2B and also position information of the region to which the instruction content is applied. When the document to be checked is checked, the scanner 15 scans the check ticket and the CPU 11 recognizes the processing content from the scanned image.

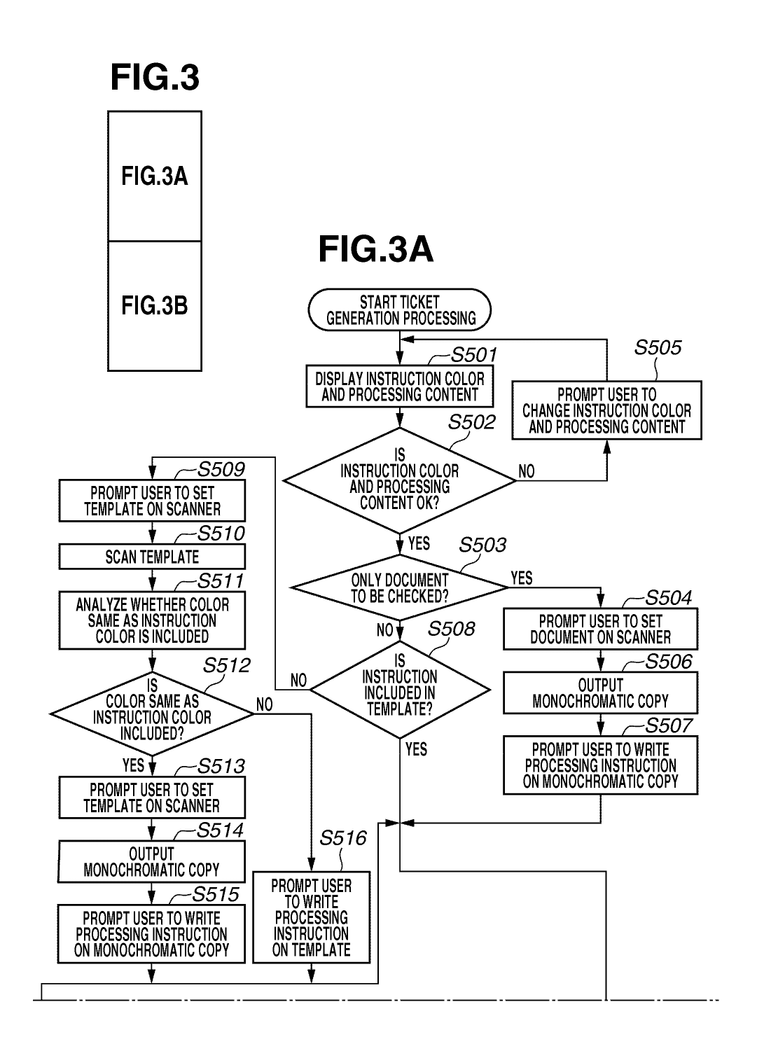

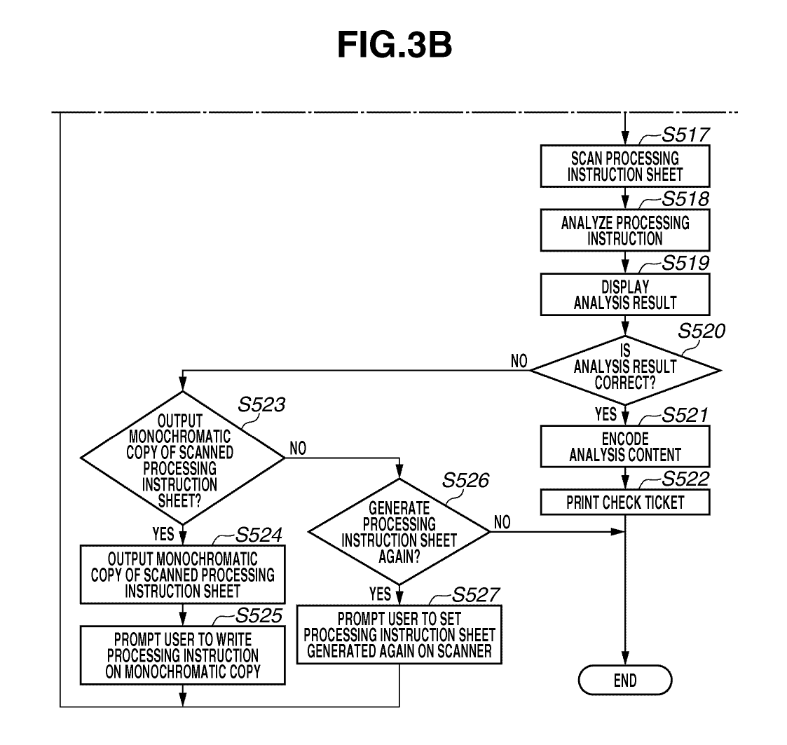

FIG. 3 is a flowchart illustrating an example of a data processing procedure of the image processing apparatus according to the present embodiment. The flowchart corresponds to the generation processing of the check ticket, and each step of the flowchart is realized by the CPU 11 loading a program stored in the ROM 19 into the RAM 18 and executing it.

Now, generation processing of the first document, which is conveyed by the document conveyance device 21 and scanned by the scanner 15, will be described. The first document, which is illustrated in FIG. 2B, has the regions identified in FIG. 2A marked with identified colors (i.e., information is added to the regions). Further, the second document corresponds to the check document which is to be checked as illustrated in FIG. 2C. The flow of the flowchart is started when the user gives an instruction to generate the check ticket via the operation unit 16. In step S501, the CPU 11 instructs the operation unit 16 to display on the display unit a combination of the instruction color of the processing instruction information and the processing content stored in the RAM 18. For example, instructions such as “OK if a region in a red rectangle includes a stamp or a signature”, “OK if a region in a blue rectangle is blank”, and “OK if any description is in a region in a green rectangle” are displayed. The color of the processing instruction information is hereinafter referred to as an instruction color. Further, the CPU 11 instructs the operation unit 16 to display on the display unit a message asking the user whether the instruction color and the processing content displayed in step S501 are adequate.

In step S502, the CPU 11 determines whether the user has determined that the combination of the instruction color and the processing content is adequate with respect to the above-described inquiry via the operation unit 16. If the CPU 11 determines that the user has not determined that the combination of the instruction color and the processing content is adequate via the operation unit 16 (NO in step S502), the processing proceeds to step S505.

In step S505, the CPU 11 instructs the operation unit 16 to display on the display unit a message prompting the user to change the combination of the instruction color and the processing content. When a message asking the user which color is to be changed is displayed, a new color which can be used in place of the designated color is presented on the display. However, an arbitrary color can be designated by the user using the operation unit 16, and further, the change can be made by not designating a new color but simply changing the combination of the color and the processing content. At this time, since the CPU 11 cannot assign one color to different processing content, the CPU 11 makes control such that one color is assigned to certain processing content.

After the change processing of either the instruction color or the processing content, or both the instruction color and the processing content is performed in step S505, the processing returns to step S501 and the CPU 11 instructs the operation unit 16 to display the combination of the instruction color and the processing content. The display of the operation unit 16 is such that the user can confirm that the change has been made in step S505.

On the other hand, in step S502, if the CPU 11 determines that the user has determined that the color and the content are adequate via the operation unit 16, the CPU 11 determines the instruction color to be used and the processing content corresponding to the determined instruction color and stores them in the RAM 18.

Since the user visually confirms the content of the document (i.e., color included in the document) in step S502, if the color component of the instruction color and the color component primarily included in the document are similar, the user can change the instruction color so that the colors are different. In this way, the occurrence of an extraction error of the processing instruction information can be prevented.

Further, as a result of the confirmation in step S502, if the CPU 11 determines that the color component primarily included in the color document and the color component of the instruction color are similar, a monochromatic copy of the document can be produced as described below. In this case, the CPU 11 instructs the operation unit 16 to display a message prompting the user to set the document on the scanner 15. When the CPU 11 determines that the document is set by the user, the CPU 11 instructs the scanner 15 to make a monochromatic copy of the document. In such a manner, the extraction error of the processing instruction information that may occur when the processing instruction information is added using a chromatic color pen can be prevented. Further, by determining whether the color component included in the document and the color component of the instruction color are different according to the user's confirmation, the number of times the document is scanned by the scanner can be reduced.

In step S502, if the CPU 11 determines that the instruction color and the processing content are adequate (YES in step S502), then the color component used in the processing instruction information is designated and stored in the RAM 18. Then, the processing proceeds to step S503. In step S503, the CPU 11 instructs the operation unit 16 to display a message asking whether the user has at hand only the document to be checked (FIG. 2C). This is to confirm whether the user has a document (see FIG. 2A or 2B) used as a template when the processing instruction sheet is generated. In other words, according to this step, even if the user has only the document to be checked at hand, a document to which the user can add the processing instruction information can be generated using the document to be checked as described below. The template is not a formal document to be checked but a document to which the user can add the processing instruction information by handwriting.

In step S503, if the CPU 11 determines that it has received a response from the user that the user has only the document to be checked (i.e., no document to be used as a template) via the operation unit 16 (YES in step S503), the processing proceeds to step S504. In step S504, the CPU 11 instructs the operation unit 16 to display a message prompting the user to set the document to be checked on the scanner 15. For example, a message such as “Set one sheet of document to be checked on scanner. Select OK button when set.” is displayed on the operation unit 16 and an OK button which is selected when the document is set is also displayed.

According to the present embodiment, the CPU 11 recognizes that the document is set when the OK button is selected. However, whether the document to be checked is set on the scanner 15 can also be automatically recognized by a photo interrupter provided under the document positioning plate or by a document sensor of the document conveyance device 21.

In step S504, if the CPU 11 determines that the user has selected the OK button of the display screen, the processing proceeds to step S506. In step S506, the CPU 11 instructs the scanner 15 to scan the image of the document to be checked. In step S506, the CPU 11 converts the image data sent from the scanner 15 into monochromatic image data and sends the obtained monochromatic image data to the printer 14. Accordingly, a monochromatic copy is produced on a recording sheet by the printer 14.

Although a monochromatic copy of the document is output by the printer 14 in step S506, printing other than monochromatic printing may also be used in the present invention. For example, the color of the image of the scanned document can be converted into a color that is different from the instruction color and then printed by the printer 14. If a red character is included in the scanned document, it can be changed into a blue character and then printed. Further, a color to be converted can be registered in advance in the RAM 18. When a color same as the registered color is found in the scanned document, that color can be converted into a different color.

In step S507, the CPU 11 instructs the operation unit 16 to display a message prompting the user to add the processing instruction information such as the information illustrated in FIG. 2B to the recording sheet output by the printer 14 in step S506. Then, the processing proceeds to step S517.

On the other hand, in step S503, if the CPU 11 determines that the user has a template document (NO in step S503), then the processing proceeds to step S508. In step S508, the CPU 11 instructs the operation unit 16 to display a message asking the user whether the processing instruction information is already included in the template as illustrated in FIG. 2B. According to this display, if the CPU 11 receives a response from the user via the operation unit 16 that the instruction information is not included in the template (NO in step S508), then the processing proceeds to step S509.

In step S509, the CPU 11 instructs the operation unit 16 to display a message prompting the user to set the template on the scanner 15. For example, an instruction such as “Set template on scanner. Select OK button when set.” and an OK button are displayed on the display unit. According to the present embodiment, the CPU 11 recognizes that the document is set when the OK button is selected. However, whether the document is set on the scanner 15 can also be automatically recognized by a photo interrupter provided under the document positioning plate or a document sensor of the document conveyance device 21.

When the CPU 11 recognizes that the OK button has been selected, the processing proceeds to step S510. In step S510, the CPU 11 instructs the scanner 15 to scan the image of the document which is to be the template. In step S511, analysis processing and recognition processing of the image data obtained by the scanning is performed to determine whether a color having a color component same as the instruction color is included in the image. According to the analysis processing, if, for example, it is recognized that a red color is included in an image of a document of a template, a red hue is extracted according to the above-described analysis processing. Various public-known methods can be used for the analysis processing and the recognition processing of the color component. Further, a parameter other than hue, or furthermore, a combination of a hue and a different parameter can also be used.

In step S512, the CPU 11 determines whether a color same as the instruction color stored in the RAM 18 is included in the color analyzed and recognized in step S511. The determination of whether the instruction color is the same as the color analyzed/recognized in step S511 is not dependent on a perfect match, and the colors can be determined as a same color if the difference is within a certain range. For example, if the color is presented in RGB values in 256 stages, by obtaining an RGB value of the analyzed/recognized color and an RGB value of the instruction color, and then comparing the RGB values, the colors may be determined as a same color if the difference between the RGB values is within 20 stages. Further, it is possible to use a determination method other than the above-described method in determining whether the colors are the same.

In step S512, if the CPU 11 determines that a color same as the instruction color stored in the RAM 18 is included in the image of the template (YES in step S512), then the process proceeds to step S513. In step S513, the CPU 11 instructs the operation unit 16 to display a message prompting the user to set the template on the scanner 15. Here, for example, an instruction such as “Set template on scanner. Select OK button when set.” and an OK button are displayed on the operation unit 16. According to the present embodiment, the CPU 11 recognizes that the document is set when the OK button is selected. However, whether the document is set on the scanner 15 can also be automatically recognized by a photo interrupter provided under the document positioning plate or a document sensor of the document conveyance device 21.

In step S513, if the CPU 11 determines that the OK button has been selected by the user, the processing proceeds to step S514. In step S514, the CPU 11 instructs the scanner 15 to scan the image of the document to be checked. Then, the CPU 11 converts the image data output from the scanner 15 into monochromatic image data and sends the obtained monochromatic image data to the printer 14 so that the printer 14 can produce a monochromatic copy on a recording sheet. Then, the processing proceeds to step S515. Although a monochromatic copy of the document is output by the printer 14 in step S514, printing other than monochromatic printing may also be used in the present invention. Various methods can be used in place of the above-described method as described in step S506.

In step S515, the CPU 11 instructs the operation unit 16 to display a message prompting the user to add the processing instruction information, such as the one illustrated in FIG. 2B, to the recording sheet output by the printer 14 in step S514. On the other hand, in step S512, if the CPU 11 determines that a color same as the instruction color stored in the RAM 18 is not included in the image of the template (NO in step S512), then the process proceeds to step S516. In step S516, the CPU 11 instructs the operation unit 16 to display a message prompting the user to add the processing instruction information, such as the one illustrated in FIG. 2B, to the template document.

On the other hand, in step S508, the CPU 11 checks whether the processing instruction information is already added to the template and if the CPU 11 determines that the user has sent a response saying that the instruction information is already added to the template via the operation unit 16 (YES in step S508), the processing proceeds to step S517.

In step S517, the CPU 11 instructs the scanner 15 to scan the image of the document of the template including the processing instruction information. The document is scanned in a manner similar to the above-described procedure used for outputting a monochromatic copy. In other words, the CPU 11 instructs the operation unit 16 to display a message prompting the user to set the document having the instruction information added, on the scanner 15. When the user sets the document on the scanner 15 and selects the OK button, the CPU 11 instructs the scanner 15 to scan the document. In this step, the CPU 11 does not convert the image data obtained from the scanner 15 into monochromatic image data. The obtained image data is stored in the RAM 18.

In step S518, the CPU 11 performs analysis and recognition processing of the processing instruction information using the image data obtained from the scanner 15. First, the CPU 11 analyzes an area where the instruction color determined in step S502 is included in the document. Then, by recognizing the color of that portion, the CPU 11 identifies the position of the region to be processed for each color. The identified position can be used in determining the position and the size of the region to be processed in the document. For example, the position can be identified by coordinates. Then, the identified position and the processing content determined in step S502 are associated with each other and stored in the RAM 18.

In step S519, the CPU 11 instructs the operation unit 16 to display the result of the analysis and recognition obtained in step S518. According to this instruction, for example, coordinates of the region corresponding to the identified processing instruction information and the processing content of that region are displayed. Further, a thumbnail image of the scanned document can be displayed. Then, the position of the processing instruction information and its processing content can be displayed identifiably vis-a-vis the thumbnail image.

In step S520, the CPU 11 instructs the operation unit 16 to display a message asking the user whether the content displayed in step S519 is correct. If the CPU 11 receives a response from the user via the operation unit 16 that the content is not correct (NO in step S520), the processing proceeds to step S523.

In step S523, the CPU 11 instructs the operation unit 16 to display a message asking the user whether a monochromatic copy of the template image obtained by the scanning performed by the scanner 15 in step S517 is to be produced by the printer 14. If the CPU 11 determines that the response from the user via the operation unit 16 is “YES” (YES in step S523), the processing proceeds to step S524.

In step S524, the CPU 11 converts the image data of the document scanned by the scanner 15 into monochromatic image data and instructs the printer 14 to produce a monochromatic copy. Thus, even if the processing instruction information is not correctly extracted, a monochromatic copy of the processing instruction sheet including the processing instruction information is produced. Then, the processing instruction information is added again to the obtained monochromatic copy. Although a monochromatic copy of the document is output by the printer 14 in step S524, printing other than monochromatic printing may also be used in the present invention. Various methods can be used in place of the above-described method as described in step S506.

In step S525, the CPU 11 instructs the operation unit 16 to display a message prompting the user to add the processing instruction information to the monochromatic copy output by the printer 14 in step S524, and then the processing proceeds to step S517.

On the other hand, in step S523, if the CPU 11 determines that the response from the user via the operation unit 16 is “NO” (monochromatic copy is not to be produced) (NO in step S523), the processing proceeds to step S526.

In step S526, the CPU 11 instructs the operation unit 16 to display a message in order to confirm whether the user desires to generate a new instruction sheet. If the CPU 11 determines that an instruction is given by the user via the operation unit 16 so that a new processing instruction sheet is generated (YES in step S526), the processing proceeds to step S527. In step S527, the CPU 11 instructs the operation unit 16 to display a message prompting the user to set the newly generated processing instruction sheet on the scanner, and then the processing returns to step S517.

On the other hand, if the CPU 11 determines that an instruction is given by the user via the operation unit 16 informing that an processing instruction sheet is not to be generated (NO in step S526), then the processing ends.

If the CPU 11 determines that, after the display in step S525 or S527, the user has set the document and selected the OK button using the operation unit 16, the process returns to step S517 and the subsequent processing described above is performed.

In step S520, if the CPU 11 determines that a response from the user saying that the analysis result is correct has been received via the operation unit 16 (YES in step S520), the content of the analysis is stored in the RAM 18 as an extraction result of the processing instruction information, and then the processing proceeds to step S521. In step S521, the CPU 11 encodes the analysis content. The coding of the analysis content is to encode the analysis result displayed in step S519 by using, for example, a two-dimensional code (e.g., QR code).

The content which is coded is the region whose processing has been instructed and the processing content of the region. Further, although a two-dimensional code is used in the present exemplary embodiment, a different method can be used in the coding so long as the image processing apparatus 100 can perform the analysis processing and the recognition processing.

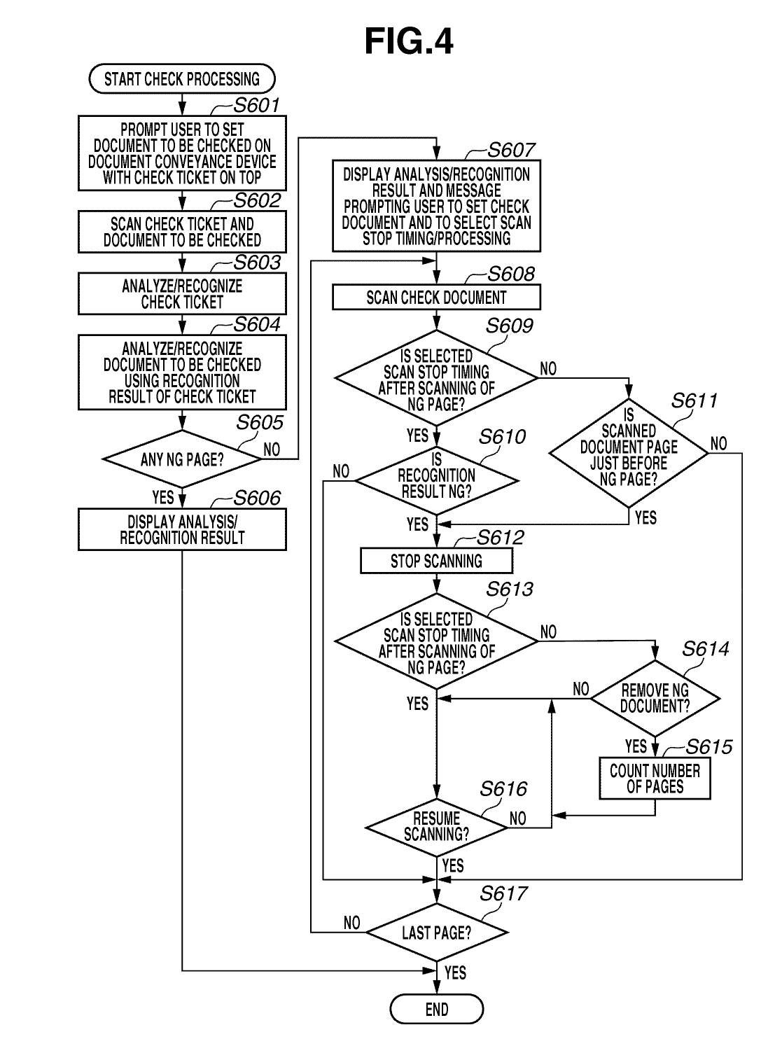

In step S522, the CPU 11 instructs the printer 14 to print the coded analysis content generated in step S521 as an image on a recording sheet, and then the processing ends. In this manner, the check ticket can be output from the printer 14. The check ticket corresponds to the first document which is scanned in step S601 in FIG. 4.

The printed check ticket can be used in checking the document to be checked (i.e., the second document). However, if the analysis result is determined as correct in step S520, it means that the processing instruction sheet scanned by the scanner 15 in step S517 is correctly recognized. Thus, steps S521 and S522 can be omitted and the processing instruction sheet scanned in step S517 can be used as a check ticket (without the above-described two-dimensional code). In this case, the processing content is recognized at the time the processing instruction sheet is checked.

According to the above-described processing, a color component included in a document is converted if it is similar to that of the instruction color, and then printed. Then, the user adds the processing instruction information to the obtained print. Since the color component included in the document is different from the instruction color, the processing instruction information added to the processing instruction sheet can be correctly recognized. Accordingly, the number of recognition errors of the processing instruction information can be reduced. Further, since necessary operations can be appropriately instructed to the user (e.g., prompting the user to produce a monochromatic copy), the possibility of operation errors can be reduced.

Not all of the processing described referring to the above-described flowchart is necessary and some of the processing can be omitted.

Next, the checking procedure of the second document according to the extracted processing instruction information using the check ticket, which has been generated as described above, will be described.

FIG. 4 is a flowchart illustrating an example of a data processing procedure of the image processing apparatus according to the present embodiment. The flowchart corresponds to document checking processing according to extracted processing instruction information using the check ticket. Each step of the flowchart is realized by the CPU 11 loading a program stored in the ROM 19 into the RAM 18 and executing it.

The flow of the flowchart is started when the user gives an instruction to check the documents to be checked via the operation unit 16. In step S601, the CPU 11 instructs the operation unit 16 to display a message prompting the user to set the documents to be checked on the document conveyance device 21 and set the check ticket printed in step S522 on the top. After the check ticket and the documents to be checked are set, if the user selects the OK button of the operation unit 16 and the CPU 11 determines that a scanning instruction of the first and the second documents is given, the processing proceeds to step S602.

In step S602, the CPU 11 sequentially conveys the documents set on the document conveyance device 21 so that the first scanning of the documents by the scanner 15 is started. First, the check ticket (the first document) which is set on top of all the documents set on the document conveyance device 21 is fed to the scanner 15 and scanned by the scanner 15. Subsequently, the first scanning of the documents to be checked (the second documents) is started, and the documents to be checked set under the check ticket are sequentially scanned. A plurality of documents to be checked can be set on the document conveyance device 21. Further, a great number of documents can be divided into a plurality of stacks and each stack can be separately set on the document conveyance device 21 and processed if it is designated via the operation unit 16 that the documents belong to the same set of documents.

In step S603, the CPU 11 performs the analysis processing and the recognition processing of the image of the first sheet scanned in step S602, in other words, the check ticket. According to the present embodiment, the CPU 11 analyzes a two-dimensional code included in the scanned check ticket using a program and recognizes the region (position) to be processed and the processing content. Then, the CPU 11 stores the result of the recognition in the RAM 18.

In step S604, the CPU 11 performs the analysis processing and the recognition processing of the second and later documents to be checked using the result of the recognition stored in the RAM 18. For example, if the second and later sheets are as illustrated in FIG. 2C, the CPU 11 recognizes that the documents are normal when a region 41 is blank, the region 42 includes information, or the region 43 includes a seal or a signature.

In making the recognition, for example, the image in the region 41 is binarized according to a predetermined threshold value. If white pixels (no image) cover, for example, 80% or more of the area, the region is recognized as a blank region. Further, the image in the region 42 is also binarized according to a predetermined threshold value. If black pixels (image exists) cover, for example, 20% or more of the area, the region is determined that it includes information.

Furthermore, if hue of red or a color similar to red is extracted from the image in the region 43, then it is binarized. If pixels cover, for example, 20% or more of the area, then the region is determined that it includes a seal or a signature. The above-described ratios are merely examples and different ratios (increased or decreased value of the above-described ratio) can also be used. Further, a different recognition method can also be used.

The CPU 11 sequentially stores the page number of the documents to be checked and the recognition result corresponding to the page in the RAM 18 each time the document to be checked is scanned. If the recognition result of all the sheets is normal, then the CPU 11 determines that the recognition result of the documents is OK. If the recognition result of any one sheet is determined as not normal, then the CPU 11 determines that the recognition result of the documents is NG. When the CPU 11 determines that the recognition processing of all the documents to be scanned is completed, the CPU 11 sums up the results with respect to the documents stored in the RAM 18.

By summing up the results, for example, a total number of the checked documents to be checked, a number of regions determined as NG, and a page number of the document including a region that has been determined as NG are obtained. Here, NG is a case where some information is included in the region 41, the region 42 is blank, or the region 43 is not stamped, or a combination of the above-described conditions is satisfied.

The first sheet of the documents to be checked in the order of the sheets scanned by the scanner 15 (the order the sheets are fed from the document conveyance device 21) excluding the check ticket is determined as the first page. Further identifiable information stored in the RAM 18 other than the information described above can be included in the summing. While the results are stored in the RAM 18 according to the present embodiment, it can also be stored in the HDD 13.

In step S605, the CPU 11 determines whether an NG document is included in the result of the processing performed in step S604. If the CPU 11 determines that an NG document is not included (YES in step S605), the processing proceeds to step S606. If the CPU 11 determines that an NG document is included (NO in step S605), the processing proceeds to step S607. Here, the NG page is a page which has been determined by the CPU 11 as not satisfying the condition set by the additional information added to the check ticket. Thus, if a document has the above-described missing stamp or characters in the region that should be blank, it is determined as an NG page.

In step S606, the CPU 11 instructs the operation unit 16 to display a result of the summing performed in step S604.

In step S607, the CPU 11 instructs the operation unit 16 to display the result of the summing performed in step S604, and also a message prompting the user to set only the check documents (documents to be checked excluding the check ticket) again and to select a scan stop timing and processing content with respect to an NG page. Regarding the scan stop timing, whether the scanning is stopped after the scanning of an NG page by the scanner 15 or the scanning of a page just before the scanning of an NG page by the scanner 15 can be selected. Here, the processing content with respect to the NG page processing is related to whether the NG page is removed or not after the scanning of the scanner 15 is stopped.

FIGS. 5A and 5B illustrate examples of a user interface displayed on the display unit of the operation unit 16 illustrated in FIG. 1. According to the user interface, the result of the summing acquired by analyzing and summing up the additional information added to the first document (check result (page number of the second document with missing information, information of the page with missing information)) by the CPU 11 is displayed.

FIG. 5A illustrates the check result display screen of the second document. The check result illustrated in FIG. 5A is displayed when all the second documents match the additional information acquired from the first document. Further, FIG. 5B corresponds to the check result display screen which is displayed when a second document that does not match the additional information acquired from the first document is detected. Furthermore, with respect to the check result display screen illustrated in FIG. 5B, a button used for setting the scanning condition of the second document according to the first document are displayed. Further, a button used for determining processing condition of the second document with missing information is also displayed on the screen when the user selects the scanning condition button and the scanning of the second document is stopped.

According to the present embodiment, as for the processing condition, whether to remove or not remove the second document which has been conveyed by the document conveyance device 21 can be selected by a button. Further, according to the present embodiment, buttons used for selecting the scanning condition are also provided. By selecting one button, the scanning stop timing with respect to the second document which has been conveyed by the document conveyance device 21 can be set just before the page identified by the document check result. By selecting another button, the scanning stop timing can be set just after the scanning of the identified page.

Further, according to the present embodiment, when the second scanning of the second documents which is executed after the recognition result is displayed is performed, only the stack of the second documents is set on the document conveyance device 21. Then, the second documents are sequentially scanned by the scanner 15. The CPU 11 controls the scanning of the second documents so that the user can re-examine the second document, whose page number which has been scanned, for example, by character recognition processing performed by an optical character reader (OCR), matches the page number extracted from the result of the document checking.

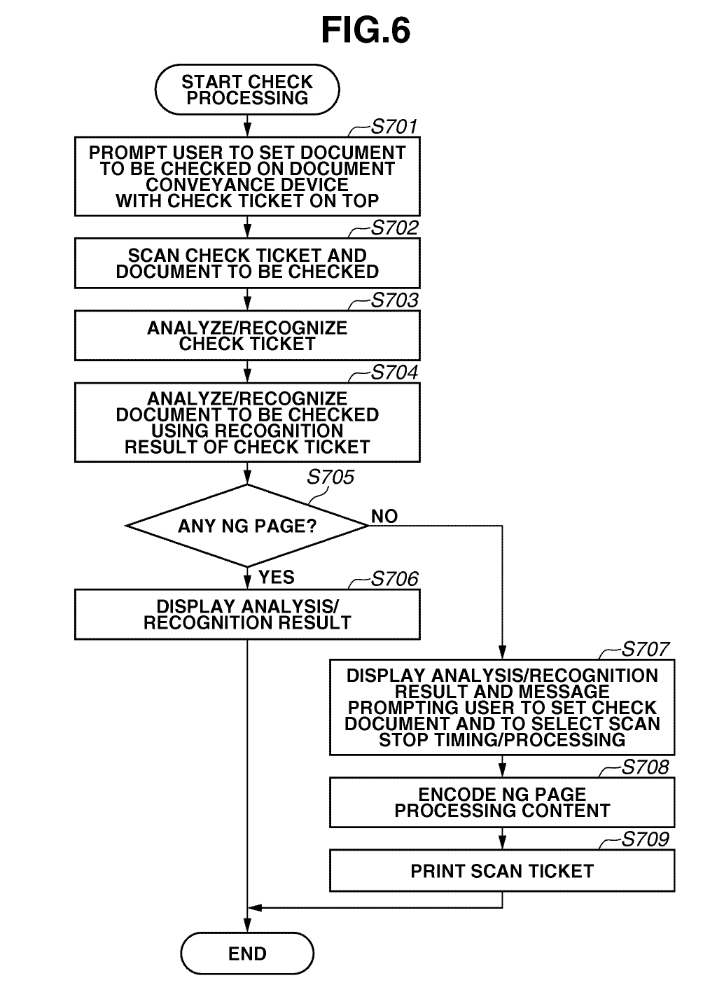

Further, the check result display screens illustrated in FIGS. 5A and 5B correspond to the screens which the CPU 11 instructs the operation unit 16 to display in steps S706 and S707 in FIG. 6.

FIG. 5A is an example of the display screen which is displayed on the operation unit 16 in step S606 when all of the documents that have been checked are determined to be normal. In FIG. 5A, the total number of pages of the documents to be checked is 100, the number of the NG region is 0 (zero), the total number of NG pages is 0 (zero), and no NG page number. Further, an OK button BT1 used for closing the screen is displayed on the display screen.

On the other hand, FIG. 5B illustrates an example of the display screen which is displayed on the operation unit 16 in step S607 when a document which has been determined as not normal is included in the documents that have been checked. In FIG. 5B, the total number of pages of the documents to be checked is 100, the number of the NG region is three, the total number of NG pages is two, and the NG page numbers are 30 and 50. Additionally, a message prompting the user to set the documents on the print paper conveyance device again and select the scan stop timing of the NG page, and a message prompting the user to select the processing content of the NG page are displayed.

Further, buttons BT2 and BT3 which the user uses in selecting the scan stop timing of the NG page are displayed on the display screen. The button BT2 corresponds to the selection of the scan stop timing after the scanning of the NG page. The button BT3 corresponds to the selection of the scan stop timing before the scanning of the NG page. Additionally, buttons BT4 and BT5 are displayed on the display screen. The button BT4 is selected when the user removes the NG page. The button BT5 is selected when the user does not remove the NG page. By selecting the buttons BT2 to BT5, the user can set the scanning condition and the processing condition of the second scanning of the second documents.

Referring back again to FIG. 4, in step S607, if the CPU 11 determines that the scanning of the documents has been instructed by the user selecting the OK button BT1 of the operation unit 16, the processing proceeds to step S608.

In step S608, the CPU 11 sequentially feeds the documents set on the document conveyance device 21 and instructs the scanner 15 to start the second scanning of the check document.

In step S609, the CPU 11 determines whether the scan stop timing selected by the user in step S607 is after the scanning of the NG page. If the CPU 11 determines that the selected scan stop timing is after the scanning of the NG page (i.e., the button BT2 is selected) (YES in step S609), the processing proceeds to step S610. On the other hand, if the CPU 11 determines that the selected scan stop timing is just before the scanning of the NG page (i.e., the button BT3 is selected) (NO in step S609), the processing proceeds to step S611.

In step S610, the CPU 11 compares the page numbers of the documents scanned in step S608 and the recognition result of the page numbers of the document to be checked stored in the RAM 18, and then determines whether the recognition result is NG. If the CPU 11 determines that the scanned document is an NG page (YES in step S610), the processing proceeds to step S612. If the CPU 11 determines that the scanned document is not an NG page (NO in step S610), the processing proceeds to step S617.

On the other hand, in step S611, the CPU 11 compares the page numbers of the documents scanned in step S608 and the page number of the first NG page stored in the RAM 18, and determines whether the page number of the scanned document is just before the page number of the first NG page. If the CPU 11 determines that the scanned document is just before the NG page (YES in step S611), the processing proceeds to step S612. If the CPU 11 determines that the scanned document is not just before the NG page (NO in step S611), the processing proceeds to step S617.

In step S612, the CPU 11 instructs the scanner 15 to stop the scanning processing of the document. In step S613, the CPU 11 determines whether the scan stop timing selected by the user in step S607 is after the scanning of the NG page. If the CPU 11 determines that the scan stop timing is after the scanning of the NG page (YES in step S613), the processing proceeds to step S616.

On the other hand, in step S613, if the CPU 11 determines that the scan stop timing is just before the scanning of the NG page (NO in step S613), the processing proceeds to step S614. In step S614, the CPU 11 determines the processing content with respect to the NG page selected by the user in step S607. If the CPU 11 determines that the user has decided not to remove the NG document or decided to remove the NG document but to return it back again (NO in step S614), the processing proceeds to step S616. On the other hand, in step S614, if the CPU 11 determines that the user has decided to remove the NG document (YES in step S614), the processing proceeds to step S615.

In step S615, the CPU 11 increments the count of the page counter that counts the number of pages scanned by the scanner 15 and stored in the RAM 18 by one. In step S616, the CPU 11 instructs the operation unit 16 to display a message asking the user whether to resume the scanning processing performed by the scanner 15. The CPU 11 waits until an instruction to resume the scanning is given by the user via the operation unit 16. (NO in step S616)

In step S616, if the CPU 11 determines that an instruction to resume the scanning operation is given by the user (YES in step S616), the processing proceeds to step S617. In step S617, the CPU 11 determines whether the page scanned by the scanner 15 is the last page. If the CPU 11 determines that the scanned page is not the last page (NO in step S617), the processing returns to step S608. If the CPU 11 determines that the scanned page is the last page (YES in step S617), the processing ends.

Although the check ticket has been used in the above-described check processing, if processing instruction information is added to a processing instruction sheet, the processing instruction sheet can be used as it is in place of the check ticket. Further, although the scan processing of the documents including an NG page is performed by the scanner 15 in the above description, the document conveyance device 21 can be configured such that it can count the page numbers without the scanner 15 performing the scanning operation.

As described above, according to the present embodiment, after the user has performed the failure/no-failure determination processing of all the documents, by setting the documents on the document conveyance device again, the NG page can be searched and usability of the user can be improved.

Further, although an image processing apparatus is taken as an example in the present embodiment, all the processing of the present embodiment can be performed based on a program if it is configured so.

According to a second exemplary embodiment, an image forming processing apparatus different from the image processing apparatus that generated the check ticket, performs the search of an NG page from a document using a scan ticket generated by the image processing apparatus. The components and processes similar to those in FIGS. 1, 2, and 3 described in the first exemplary embodiment are denoted by the same reference numerals and process numbers, and their descriptions are not repeated.

Different procedures for checking the document according to processing instruction information which has been extracted from the check ticket generated according to the procedures described in the first exemplary embodiment will now be described.

FIG. 6 is a flowchart illustrating an example of a data processing procedure of the image processing apparatus according to the present embodiment. This flowchart corresponds to the flow of processing used for checking the documents to be checked by using the check ticket and the scan ticket which is generated according to the scanning condition and the processing condition set by the user. Each step of the flowchart is realized by the CPU 11 loading a program stored in the ROM 19 into the RAM 18 and executing it.

The flow of the flowchart is started when the user gives an instruction to check the documents to be checked via the operation unit 16. In step S701, the CPU 11 instructs the operation unit 16 to display a message prompting the user to set the check documents on the document conveyance device 21 and set the check ticket printed in step S522 on the top.

After the check ticket and the check documents are set, if the user selects the OK button of the operation unit 16 and the CPU 11 determines that a scanning instruction is given, the processing proceeds to step S702.

In step S702, the CPU 11 sequentially conveys the documents set on the document conveyance device 21 so that scanning of the documents by the scanner 15 is started. In other words, the check ticket, which is the first sheet of all the documents set on the document conveyance device 21 is fed to the scanner 15 and scanned by the scanner 15. Subsequently, the documents to be checked, which are set under the check ticket are sequentially scanned. A plurality of documents to be checked can be set on the document conveyance device 21. Further, a great number of documents can be divided into a plurality of stacks and each stack can be separately set on the document conveyance device 21 and processed if it is designated via the operation unit 16 that the documents belong to the same set of documents.

In step S703, the CPU 11 performs the analysis processing and the recognition processing of the image of the first sheet scanned in step S702, in other words, the check ticket. According to the present embodiment, the CPU 11 analyzes a two-dimensional code included in the scanned check ticket and recognizes the region (position) to be processed and the processing content. Then, the CPU 11 stores the result of the recognition in the RAM 18.

In step S704, the CPU 11 performs the analysis processing and the recognition processing of the second and later documents to be checked using the result of the recognition stored in the RAM 18. For example, if the second and later sheets are as illustrated in FIG. 2C, the CPU 11 recognizes that the documents are normal when a region 41 is blank, when the region 42 includes information, or when the region 43 includes a seal or a signature. In making the recognition, for example, the image in the region 41 is binarized according to a predetermined threshold value. If white pixels (no image) cover, for example, 80% or more of the area, the region is recognized as a blank region.

Further, the image in the region 42 is also binarized according to a predetermined threshold value. If black pixels (image exists) cover, for example, 20% or more of the area, the region is determined that it includes information. Furthermore, if hue of red or a color similar to red is extracted from the image in the region 43, then it is binarized. If pixels cover, for example, 20% or more of the area, then the region is determined that it includes a seal or a signature. The above-described ratios are merely examples and different ratios can also be used. Further, a different recognition method can also be used.

The CPU 11 sequentially stores the page number of the documents to be checked and the recognition result corresponding to the page in the RAM 18. If the recognition result of all the sheets is normal, then the CPU 11 determines that the recognition result of the documents is OK. If the recognition result of any one sheet is determined as not normal, then the CPU 11 determines that the recognition result of the documents is NG. When the CPU 11 determines that the recognition processing of all the documents to be scanned is completed, the CPU 11 sums up the results with respect to the documents stored in the RAM 18.

By summing up the results, for example, a total number of the checked target documents, a number of regions determined as NG, and a page number of the document that includes the region determined as NG are obtained. The first sheet of the documents to be checked in the order of the sheets scanned by the scanner 15 (the order the sheets are fed from the document conveyance device 21) excluding the check ticket is determined as the first page. Further identifiable information stored in the RAM 18 other than the information described above can be included in the summing. While the results are stored in the RAM 18 according to the present embodiment, it can also be stored in the HDD 13.

In step S705, the CPU 11 determines whether an NG document is included in the result of the processing performed in step S704. If the CPU 11 determines that an NG document is not included (NO in step S705), the processing proceeds to step S706. If the CPU 11 determines that an NG is included (YES in step S705), the processing proceeds to step S707.

In step S706, the CPU 11 instructs the operation unit 16 to display the result of the summing performed in step S704, and then the processing ends.

In step S707, the CPU 11 instructs the operation unit 16 to display the result of the summing performed in step S704, and also a message prompting the user to set only the check documents again and to select a scan stop timing and processing content with respect to an NG page. Regarding the scan stop timing, whether the scanning is stopped after the scanning of an NG page by the scanner 15 or the scanning of a page just before the scanning of an NG page by the scanner 15 can be selected. The processing content with respect to the NG page processing is related to whether the NG page is removed or not after the scanning of the scanner 15 is stopped.

In step S706, the CPU 11 displays the check display screen illustrated in FIG. 5A on the operation unit 16 as the screen displayed when all the documents to be checked whose check result is displayed on the operation unit 16 are determined to be normal. The display processing according to the present embodiment will now be described with reference to FIG. 5.

In FIG. 5A, the total number of pages of the documents to be checked is 100, the number of the NG region is 0 (zero), the total number of NG pages is 0 (zero), and no NG page number. Further, the OK button BT1 used for closing the screen is displayed on the display screen.

On the other hand, FIG. 5B illustrates an example of the display screen which is displayed on the operation unit 16 in step S707 when a document which has been determined as not normal is included in the documents that have been checked. In FIG. 5B, the total number of pages of the documents to be checked is 100, the number of the NG region is three, the total number of NG pages is two, and the NG page numbers are 30 and 50. Additionally, a message prompting the user to set the documents on the print paper conveyance device again and select the scan stop timing of the NG page, and a message prompting the user to select the processing content of the NG page are displayed.

Further, the buttons BT2 and BT3 which the user uses in selecting the scan stop timing of the NG page are displayed on the display screen. As described above, the button BT2 corresponds to the selection of the scan stop timing after the scanning of the NG page. The button BT3 corresponds to the selection of the scan stop timing before the scanning of the NG page. Additionally, the buttons BT4 and BT5 are displayed on the display screen. The button BT4 is selected when the user removes the NG page. The button BT5 is selected when the user does not remove the NG page.

In step S708, the CPU 11 generates a QR code of the processing content of the NG page which has been selected by the user in step S707, and stores the generated QR code in the RAM 18.

In step S709, the CPU 11 generates a scan ticket that includes the QR code generated in step S708, and instructs the printer 14 to print the scan ticket. Then, the processing ends. In this manner, by using the buttons BT2 and BT3, the scanning condition and the processing condition set by the user can be printed. Further, by using the document check result displayed in step S707, a third document (scan ticket) can be printed. The third document is used for controlling scanning of the second documents which are scanned by an image processing apparatus other than the image processing apparatus that printed the scan ticket. When the image processing apparatus other than the image processing apparatus that printed the third document scans the third and the second documents, a second document with missing information at a predetermined region can be extracted by the image processing apparatus other than the image processing apparatus that printed the scan ticket.

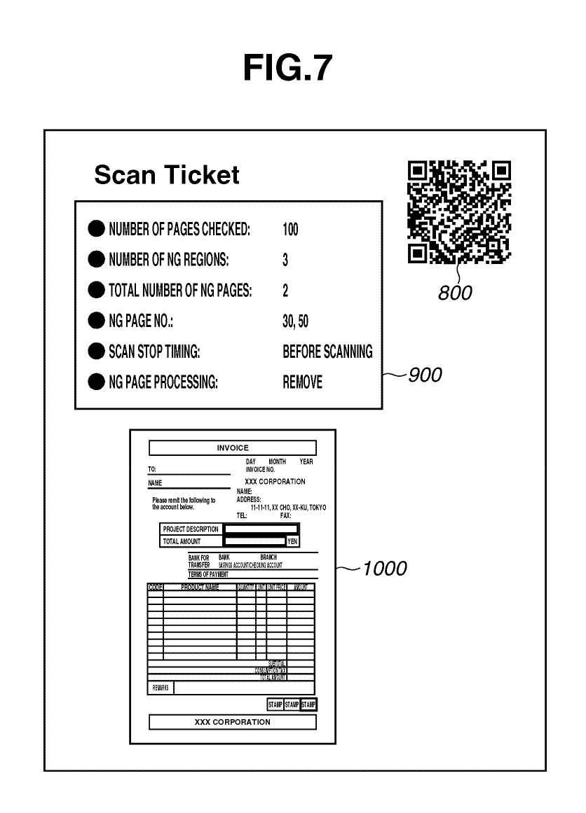

FIG. 7 illustrates an example of the scan ticket used by the image processing apparatus according to the present embodiment. The scan ticket in FIG. 7 is an example of a scan ticket generated according to the check processing result and the processing content selected by the user in step S707.

In FIG. 7, the scan ticket includes a QR code 800 which is processing instruction information and is coded, a thumbnail image 1000, and processing result content 900. The QR code 800 includes information of the scanning condition and the processing condition of the second document set by the user in step S707 in FIG. 6. Thus, if a scanner of an image processing apparatus other than the image processing apparatus that printed the scan ticket scans the scan ticket, the image processing apparatus of that scanner can check the second document. The processing result content 900 indicates a result of the processing performed by the CPU 11 in step S704.

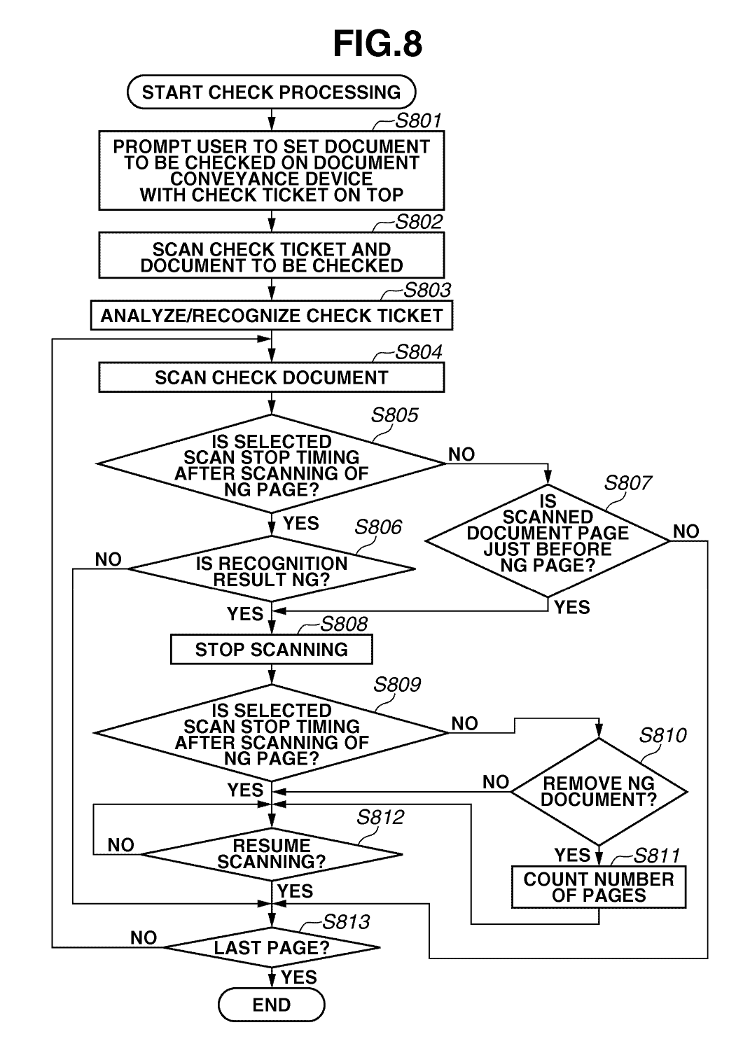

FIG. 8 is a flowchart illustrating an example of data processing procedures of the image processing apparatus according to the present embodiment. The processing of the flowchart corresponds to the flow of check processing used for searching an NG page by using the scan ticket generated according to the flow in FIG. 6 and illustrated in FIG. 7. Each step of the flowchart is realized by the CPU 11 loading a program stored in the ROM 19 into the RAM 18. The flow of the flowchart is started when the user gives an instruction to check the document to be checked via the operation unit 16.

The flow of the flowchart is started when the user gives an instruction to check the document to be checked via the operation unit 16. In step S801, the CPU 11 instructs the operation unit 16 to display a message prompting the user to set the check documents on the document conveyance device 21 and set the scan ticket printed in step S709 on the top.

Next, after the documents are set, if the scanning of the documents is instructed according to, for example, the user selecting the OK button of the operation unit 16, the processing proceeds to step S802.

In step S802, the CPU 11 sequentially feeds the documents set on the document conveyance device 21 and instructs the scanner 15 to scan the documents. In other words, the scan ticket being the first sheet of all the documents set on the document conveyance device 21 is fed to the scanner 15 and the scan ticket is scanned by the scanner 15. Subsequently, the documents to be checked set under the scan ticket are sequentially scanned. A plurality of documents to be checked can be set on the document conveyance device 21. Further, a great number of documents can be divided into a plurality of stacks and each stack can be set on the document conveyance device 21 separately and processed if it is designated via the operation unit 16 that the documents belong to the same set of documents.

In step S803, the CPU 11 performs the analysis processing and the recognition processing of the image of the first sheet scanned in step S802, in other words, the scan ticket. According to the present embodiment, the CPU 11 analyzes a two-dimensional code included in the scanned scan ticket and recognizes the region (position) to be processed and the processing content. Then, the CPU 11 stores the result of the recognition in the RAM 18.

In step S804, the CPU 11 sequentially feeds the documents set on the document conveyance device 21 and instructs the scanner 15 to start the scanning of the documents. In step S805, the CPU 11 determines whether the scan stop timing selected by the user in step S707 is after the scanning of the NG page. If the CPU 11 determines that the selected scan stop timing is after the scanning of the NG page (YES in step S805), the processing proceeds to step S806. On the other hand, if the CPU 11 determines that the selected scan stop timing is just before the scanning of the NG page (NO in step S805), the processing proceeds to step S807.

In step S806, the CPU 11 compares the page numbers of the document scanned in step S804 and the recognition result of the page numbers of the document to be checked stored in the RAM 18, and then determines whether the recognition result is NG. If the CPU 11 determines that the scanned document is an NG page (YES in step S806), the processing proceeds to step S808. If the CPU 11 determines that the scanned document is not an NG page (NO in step S806), the processing proceeds to step S813.

In step S807, the CPU 11 compares the page numbers of the documents scanned in step S804 and the page number of the first NG page stored in the RAM 18, and determines whether the page number of the scanned document is just before the page number of the first NG page. If the CPU 11 determines that the scanned document is just before the NG page (YES in step S807), the processing proceeds to step S808. If the CPU 11 determines that the scanned document is not just before the NG page (NO in step S807), the processing proceeds to step S813.

In step S808, the CPU 11 instructs the scanner 15 to stop the scanning processing of the document. In step S809, the CPU 11 determines whether the scan stop timing selected by the user in step S707 is after the scanning of the NG page. If the CPU 11 determines that the scan stop timing is after the scanning of the NG page (YES in step S809), the processing proceeds to step S812. Further, if the CPU 11 determines that the scan stop timing is just before the scanning of the NG page (NO in step S809), the processing proceeds to step S810.

In step S810, the CPU 11 determines the processing content with respect to the NG page selected by the user in step S707. If the CPU 11 determines that the user has decided not to remove the NG document or decided to remove the NG document but to return it back again (NO in step S810), the processing proceeds to step S812. On the other hand, in step S614, if the CPU 11 determines that the user has decided to remove the NG document (YES in step S810), the processing proceeds to step S811. In step S811, the CPU 11 increments the count of the page counter that counts the number of pages scanned by the scanner 15 and stored in the RAM 18 by one, and then the processing proceeds to step S812.

In step S812, the CPU 11 instructs the operation unit 16 to display a message asking the user whether to resume the scanning processing performed by the scanner 15. The CPU 11 waits until an instruction to resume the scanning is given by the user via the operation unit 16. If the CPU 11 determines that an instruction to resume the scanning operation is given by the user (YES in step S812), the processing proceeds to step S813.

In step S813, the CPU 11 determines whether the page scanned by the scanner 15 is the last page. If the CPU 11 determines that the scanned page is not the last page (NO in step S813), the processing returns to step S804. If the CPU 11 determines that the scanned page is the last page (YES in step S813), the processing ends.

Although the scan ticket has been used in the above-described check processing, in place of the scan ticket, if processing instruction information is added to a processing instruction sheet, the information-added processing instruction sheet can be used as it is.

Further, although the scan processing of the documents including an NG page is performed by the scanner 15 in the above description, the document conveyance device 21 can be configured such that it can count the page numbers without the scanner 15 performing the scanning operation.

Further, the image processing apparatus that performs the check processing described according to the flowchart illustrated in FIG. 6 and the image processing apparatus performing the check processing described according to the flowchart illustrated in FIG. 8 can be different apparatuses.

As described above, according to the present embodiment, the scan ticket which is helpful in searching an NG page by an image processing apparatus other than the image processing apparatus that printed the scan ticket or by the image processing apparatus that printed the scan ticket at a later time for searching can be obtained after the user has performed the failure/no-failure determination processing with respect to all the documents. Since the failure/no-failure determination processing and the NG page search processing can be performed at a different time, and further, the NG processing can be performed by a different image processing apparatus, usability is improved.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-278549 filed Dec. 8, 2009, which is hereby incorporated by reference herein in its entirety.

What is claimed is:

1. An image reading apparatus comprising:
a reading unit configured to read a document having a plurality of pages conveyed by a document conveyance device;
a checking unit configured to check image data of each page of the plurality pages of the document read by the reading unit; and
a control unit configured to stop conveyance of the document at timing which is determined according to a check result performed by the checking unit when the document having the plurality of pages set on the document conveyance device is conveyed after the document having the plurality of pages is read by the reading unit.

2. An image reading apparatus according to claim 1, further comprising an urging unit configured to urge an user to set the document having the plurality of pages on the document conveyance device after the document is read by the reading unit.

3. An image reading unit according to claim 1, further comprising a selecting unit configured to select timing to stop conveyance of the document between prior to or after a page determined by checking of the checking unit.

4. An image reading apparatus according to claim 1, further comprising a printing unit configured to print a scan ticket used for determining timing at which another image reading apparatus stops conveyance of the document according to a result of checking performed by the checking unit.

5. An image reading apparatus according to claim 1, further comprising a display unit configured to display a result of checking performed by the checking unit.

6. A control method for controlling an image reading apparatus, comprising:
reading a document having a plurality of pages which is conveyed by a document conveyance device by a reading unit;
checking image data of each page of the document having the plurality of pages read by the reading unit; and
controlling, when the document having the plurality of pages set on the document conveyance device is conveyed after the document having the plurality of pages is read by the reading unit, conveyance of the document to stop at timing according to a result of the checking.

7. A computer readable storage medium for storing a computer-executable process, the computer-executable process causing a computer to perform a method for controlling an image reading apparatus, comprising:
reading a document having a plurality of pages which is conveyed by a document conveyance device by a reading unit;
checking image data of each page of the document having the plurality of pages read by the reading unit; and
controlling, when the document having the plurality of pages set on the document conveyance device is conveyed after the document having the plurality of pages is read by the reading unit, conveyance of the document to stop at timing according to a result of the checking.
